(19) United States
(12) Patent Application Publication
(10) Pub. No.: US 2007/0261061 A1
(43) Pub. Date: Nov. 8, 2007

(54) System and method of aggregating and consolidating security event data

(76) Inventors: Stuart Guesley Staniford, San Francisco, CA (US); Tanuj Mohan, San Jose, CA (US); Harpreet Sawhney, Pune (IN); Prashant Wasudeo Bhagdikar, Pune (IN)

Correspondence Address: PATRICK REILLY, BOX 7218, SANTA CRUZ, CA, 95061-7218, US

(21) Appl. No.: 11/286,518

(22) Filed: Nov. 26, 2005

(51) Int. Cl. G06F 3/00

(52) U.S. Cl. 719/318

(57) ABSTRACT

A method and system are provided that enable the processing of security event data is provided. In a first version, instructions for processing security event data are software encoded in separate modules. The software is organized into discrete modules and executed by an information technology system. The software as executed identifies the computational engines of the information technology available for processing the security event data and assigns modules to specific computational engines. A plurality of events stored in a buffer are processed sequentially through two or more modules. The results of each processing of an event by a module are recorded in an extended event structure and made accessible to a successive module. The location of the buffer storing an event is available for overwriting after the event has been fully processed.

### FIELD OF THE INVENTION

The present invention relates to the robustness and integrity of electronic communications networks. More particularly, the present invention relates to techniques for generating and processing information, messages and activity logs related to electronic communications, to include information related to the activity and security of an electronic communications network and resources thereof.

### BACKGROUND OF THE INVENTION

Electronic communications networks, such as segments of the Internet to include intra-nets and extra-nets, are often monitored by means of generating logs of communications activity and/or protected by firewalls and other suitable intrusion detection software known in the art. In one area of prior art, intrusion detection systems examine in-coming electronic messages for indications that one or more messages are related to, or part of, an intrusion attempt. Event correlation techniques in particular are widely used to determine the significance of individual and pluralities of server and router activity logs and firewall processing. In certain prior art systems, when an intrusion detection is suspected, a network or electronic communications security event message (hereafter “event”) is generated and the event is correlated with other potentially related events. The resulting event correlation information may be analyzed along with information contained within or related to one or more particular events, to estimate the likelihood that one or more events are related to an actual intrusion attempt, as well as to evaluate the significance and possible virulence of a suspected intrusion attempt or other communications anomaly. The processing of the events can be a complex activity and may involve dozens of stages of evaluation and modification of the event that may require significant amounts of computational resources of a computer network.

Intrusion detection software is most commercially valuable if the software can be applied on many or most types of computational systems that are deployed to perform intrusion detection and event processing. Furthermore, in a deployed state, a computational system that is tasked with intrusion detection may have additional and significant tasks to perform. In addition, the use of numerous types of computational systems in communications networks, where different types of systems may have more than one processing unit, and each processing may have more than one processing core, can lead to the suboptimal application of a specific computational system's resources by prior art intrusion detection software. There is therefore a long felt need to provide intrusion detection software that can run on a variety of hardware platforms and conform to the operation of a host computer to more efficiently apply the available computational resources to execute event processing

### SUMMARY OF THE INVENTION

Towards these objects, and other objects that will be made obvious in light of the present disclosure, a method and system are provided to process events in more than one type of computational system. In accordance with a first preferred embodiment of the Method of the Present Invention, a first software version is design to comprise a plurality of modules. Each module (hereafter “stage”) is sequentially applied to an event and each stage may be separately assigned to an individual and differentiated computational resource (hereafter “computational engine”).

In certain alternate preferred embodiments of the Method of the Present Invention, software is provided comprising machine-readable instructions that direct an information technology system to perform information processing by means of applying the stages to the information, e.g. to events. The instant software is then provided to the information technology system, and the provided software determines the number of computational engines available for security event processing. In one exemplary preferred embodiment of the Method of the Present Invention, the computational engine is defined as an electronic logic device preferably capable of executing software instructions with computational power exceeding, or comparable to, the computational power of a core of an INTEL PENTIUM D PROCESSOR™ microprocessor. Each available computational engine is tasked by the software with executing at least one stage. The information technology system then processes a plurality or multiplicity of events by applying the stages as directed by the software.

In certain still alternate preferred embodiments of the Method of the Present Invention the events are stored in a main event buffer and a pipeline is established to process the events. The pipeline includes a plurality of stages, wherein the stages are typically applied to any given event in a temporal order and within a standard or pre-established ordered sequence. The main buffer may be a circular buffer, and may store each or most events in an event space, the event space storing the event, a stage index and an extended event structure. The stage index indicates the identity of the last stage applied against the event. The extended event structure records information related to, or generated during, the processing of the event.

Stages may be grouped together into threads, and a thread may sequentially apply several stages to a range of events in the main event buffer. A stage typically reads an event, looks up a relevant row in a state table, performs some computation, and then updates the row, the event, or both (here the event is taken to include an extended event structure). Stages typically cannot make assumptions as to whether they are applied horizontally, i.e., wherein one stage is applied to numerous events before a next stage is applied, or vertically, i.e., wherein numerous stages are applied to one event before the next). Stages may be designed, in certain other alternate preferred embodiments of the Method of the Present Invention, to function regardless of how the stages are grouped together into threads. The pipeline and stages can be designed to not require that events be processed in an exact order, though the pipeline and stages may optionally be designed and applied to operate within, and conform, to the time bounds enforced by a thread.

### BRIEF DESCRIPTION OF THE DRAWINGS

These, and further features of the invention, may be better understood with reference to the accompanying specification and drawings depicting the preferred embodiment, in which:

FIG. 1 is a schematic of an electronic communications network;

FIG. 2 is a schematic diagram of a first system that is communicatively coupled with and comprised within the network of FIG. 1;

FIG. 3 is a schematic diagram of an additional processor of the first system of FIG. 2 in communication with an off-chip cache memory of the first system of FIG. 2;

FIG. 4 is a process diagram of an event of FIGS. 1 and 6;

FIG. 5 is a schematic diagram of a buffer of the first system of FIG. 2;

FIG. 6 is a format diagram of an event of FIG. 6 stored within the first system of FIG. 2 via the network of FIG. 1;

FIG. 7 is a format diagram of an event space of the buffer of FIG. 2 formatted for and capable of storing the event of FIG. 6, a stage index and an extended event;

FIG. 8 is a schematic diagram of a plurality of event spaces of FIG. 7 within a buffer of FIG. 2, FIG. 3 and FIG. 5;

FIG. 9 is a schematic diagram of a pipeline of stages instantiated in the first system of FIG. 2 and configured to process a plurality of events of FIG. 6 and as stored in a buffer of FIG. 5;

FIG. 10 is a process chart of the first method that may be performed by means of the communications network of FIG. 1 and the first system of FIG. 2;

FIG. 11 is a flow chart of the generation of an event of FIG. 6 in accordance with the first method of FIG. 10 and by means of the communications network of FIG. 1 and the first system of FIG. 2;

FIG. 12 is a flowchart of the processing of an event of FIG. 6 by the first system of FIG. 2 and in accordance with the first method of FIG. 10;

FIG. 13 is a flowchart of an application of a thread of the pipeline of FIG. 9 by the first system of FIG. 2; and

FIG. 14 illustrates an optional method of still other additional alternate preferred embodiments of the Method of the Present Invention to checkpoint information related to each stage of FIG. 8 by means of a checkpoint event of FIG. 8 is processed by the pipeline of FIG. 9.

### DETAILED DESCRIPTION OF THE PREFERRED EMBODIMENT

The following description is provided to enable any person skilled in the art to make and use the invention and sets forth the best modes contemplated by the inventor of carrying out his or her invention. Various modifications, however, will remain readily apparent to those skilled in the art, since the generic principles of the Present Invention have been defined herein.

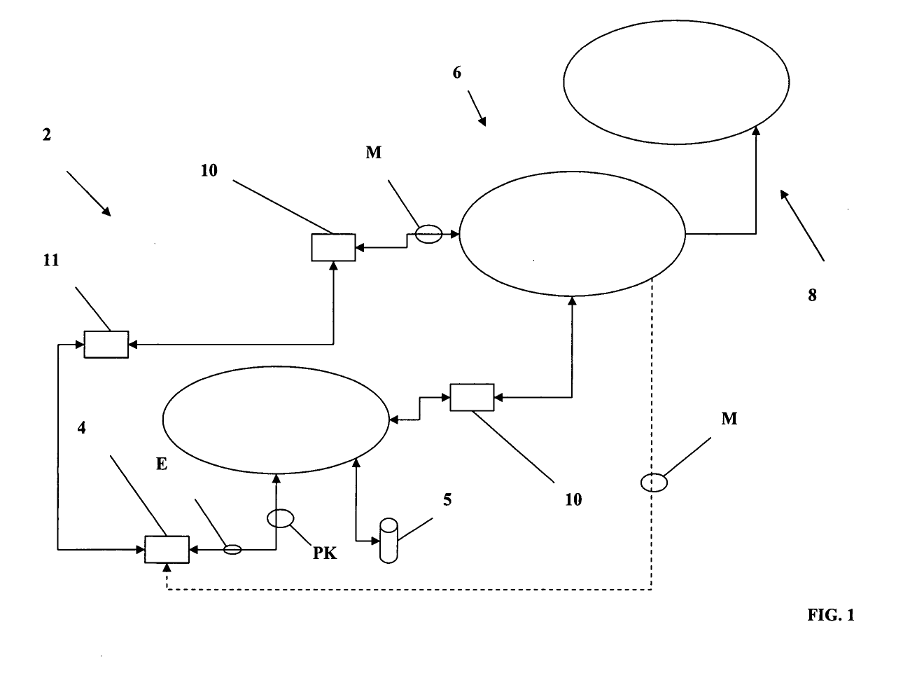

Referring now generally to the Figures and particularly to FIG. 1, FIG. 1 presents an electronic communications network 2 including the computer system 4 (hereafter “first system” 4) and memory storage systems 5. The communications network 2 may be communicatively coupled with an external computer network 6. The communications network 2 and the external computer network 6 are capable of supporting digital electronics message traffic and may be, comprise, or be comprised within, an electronics communications network such a telephony network, a computer network, an intranet, and an extranet and/or the Internet 8.

A plurality of network computers 10 of the communications network 2 receive electronic messages M originating from within the communications network 2, from the external computer network 6 and/or the Internet 8. Internal computers 11 are distinguished from network computers 10 in that internal computers 11 are elements of the electronic communications network 2 but have all communications beyond the electronic communications network 2 are mediated by a network computer 10 or the first system 4. Optionally, additionally or alternatively, one or more electronic messages M of the message traffic received by the first system 4 may be generated by the first system 4 itself, one of the network computers 10, the Internet 8, and/or the external computer network 6. In certain preferred embodiments of the Method of the Present Invention the first system 4 may be in communication with the external network computer 6 and/or the Internet 8 and receive events E and/or messages M substantially unprocessed therefrom.

One or more messages M may optionally contain information related to the activity of the communications network 2, external network 6, an unauthorized attempt of intrusion targeting the communications network 2, and/or a possible unauthorized attempt of intrusion targeting the communications network 2.

The first system 4 may receive events E, and alternatively or additionally messages M from which events E may be at least partially derived. The events E and the messages M may be communicated to the first system 4 from the external computer network 6 and/or the network computers 10 via the communications network 2. The communications network 2 and the external computer network 6 may be, comprise, or be comprised within, an electronics communications network such a telephony network, an intranet, and extranet and/or the Internet 8.

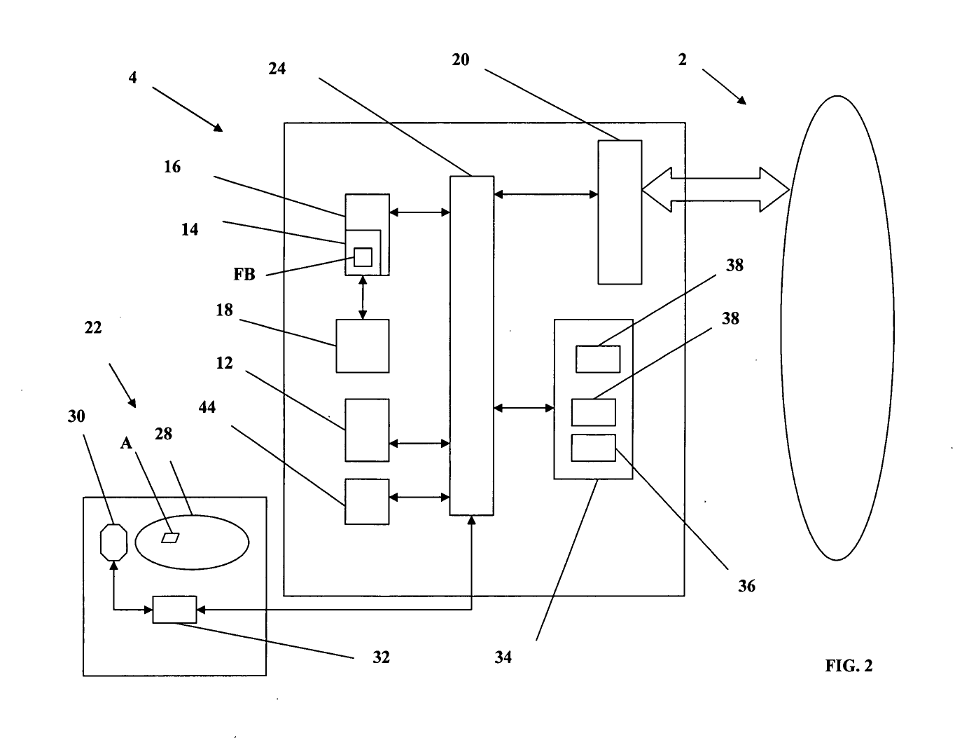

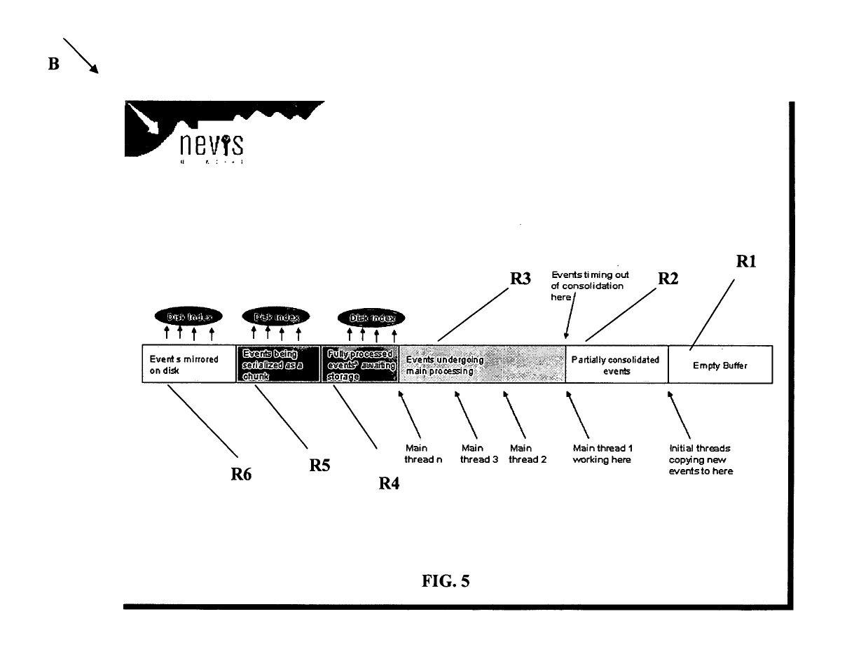

Referring now generally to the Figures and particularly to FIG. 2, FIG. 2 is a schematic of the first system 4 of the electronic communications network 2 of FIG. 1. It is understood that each network computer 10 may comprise one or more the elements 16-42 of the first system 4. The pipeline P and the circular buffer B of FIG. 5 may, in various alternate preferred embodiments of the Method of the Present Invention, be instantiated and maintained in a main memory 12, the on-chip cache memory 14 of a central processing unit 16, and/or an off-chip cache memory 18 of the first system 4 as a whole or in a distributed data structure. The first system 4 also includes a network interface 20 and a secondary memory 22. A communications bus 24 of the first system 4 bi-directionally communicatively couples the central processing unit 16, the off-chip cache memory 18, the network interface 20, the main memory 12 and the secondary memory 22. The secondary memory 22 includes the data storage disk 28, a disk motor 30 and a controller 32. The controller 32 reads and writes data to and from the data storage disk 28 and the central processing unit 16 (hereafter “CPU” 16). The controller 32 additionally directs the operations of the disk motor 28 to enable the reading and writing to and from the data storage disk 28. In addition, the first system 4 may have one or more additional processors 34 having a first core 36, and one or more additional cores 38. The additional processors 34 and the cores 36 and 38 may each be tasked with executing a separate thread of the first method. It is understood that the term computational engine is defined herein to include electronic processors, digital microprocessors and cores and elements of logic devices that are configured to execute a stage as assigned by the first method, such as an INTEL PENTIUM D PROCESSOR™ microprocessor. It is further understood that the term computer is defined herein to include an electronic device or system that is capable of carrying out a sequence of operations in defined manner, wherein the operations are numeric computations and data manipulations that accept data input and generate informational output.

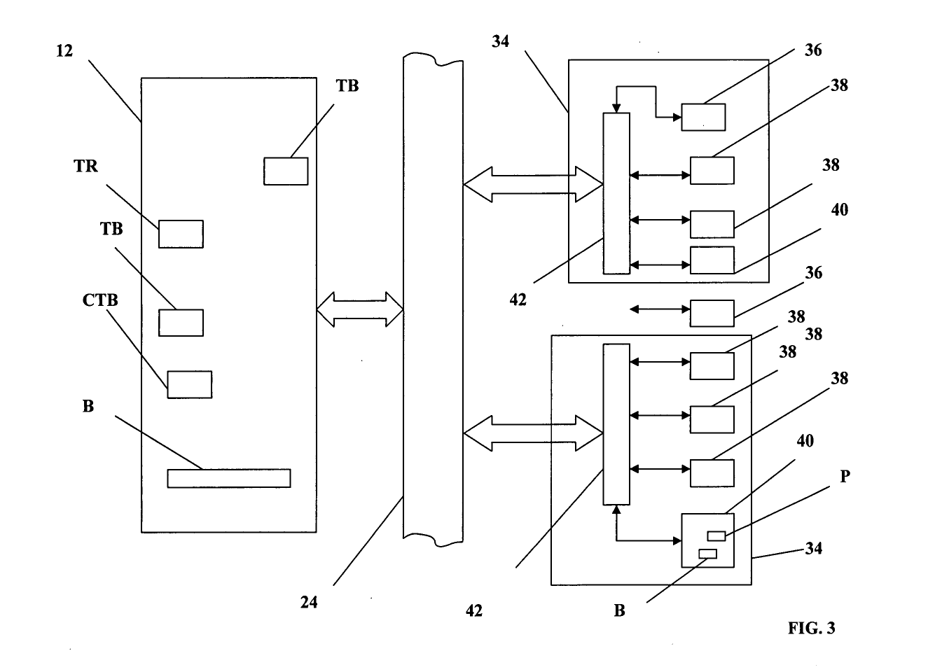

Referring now generally to the Figures, and particularly to FIG. 3, FIG. 3 is a schematic diagram of additional processors 34 of the first system 4 of FIG. 2 in communication with an off-chip cache memory 18 of the first system 4. Each additional processor 34 has one or more cores 36 and 38, and on-chip cache memory 40. The cores of the additional processors 34 communicate with the off-chip cache memory 18 via the communications bus 24 and an internal communications bus 42. The pipeline P and the circular buffer B of FIG. 5 may, in various yet alternate preferred embodiments of the Method of the Present Invention, be instantiated and maintained in the additional processors 34 as well as the main memory 12, the on-chip cache memory 14 of a central processing unit 16, and/or an off-chip cache memory 18 of the first system 4 as a whole or in a distributed data structure.

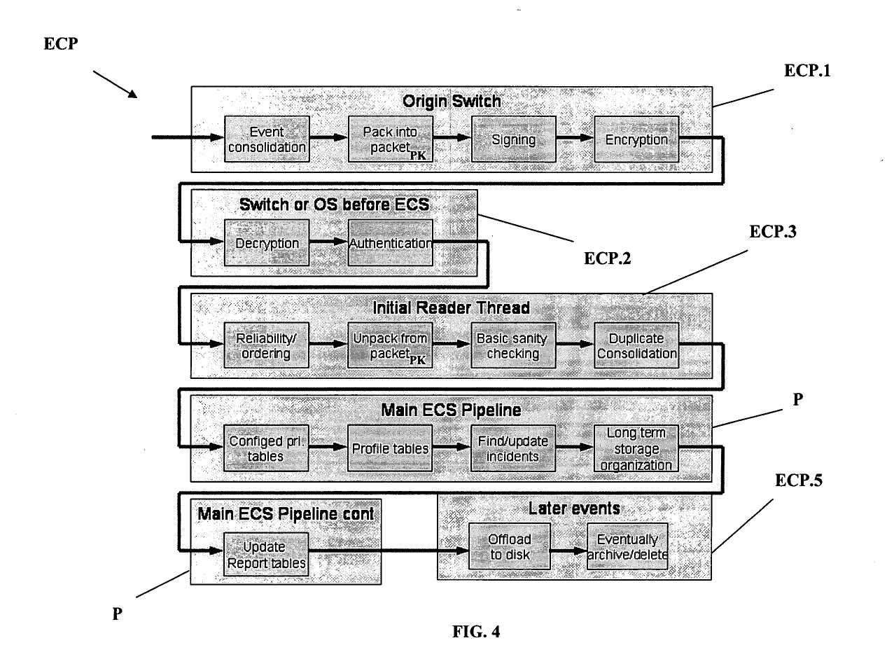

Referring now generally to the Figures and particularly to FIG. 4, FIG. 4 is an overview of the lifecycle of an event E from creation by a network computer 10 or the first system 4, to deletion or recordation in the secondary memory 22. FIG. 4 provides illustrative examples of one or more kinds of event E or message processing M processes that might be incorporated into an event correlation pipeline ECP as described herein that may be performed by one or network security devices 10, internal computers 11 or the first system 4 in a distributed computational technique, in singularity and/or in combination. The first segment ECP.1 of the event correlation process ECP includes a consolidating of related events E and messages M, combining the events E and/or messages M together into an event packet data PK, signing the packet data PK and encrypting the packet data PK before transmitting for event correlation by a network computer 10, an internal computer 11, or the first system 4, where the packet data PK may in a second segment ECP.2 of the event encryption pipeline ECP be decrypted and checked for correct authentication.

Within the third segment ECP.3 of the event correlation pipeline ECP, an ordering of events E may be checked, and any missing events E detected and retransmission arranged for. Then the packet PK may be parsed and events E may be delineated within the event packet PK. The events E may then be checked for basic syntactic correctness.

In addition and within the third segment ECP.3, events E generated by duplicate observations of a same occurrence observed by various elements 4, 5, 10, and 11 of the network 2 may be consolidated together. As an example of consolidating duplicative observations, consider that where a network connection crosses numerous computers 4, 10, 11, where each computer 4, 10 & 11 may log the existence and progress of the same instance of connection and issue a separate event E comprising information related the observation of the same occurrence.

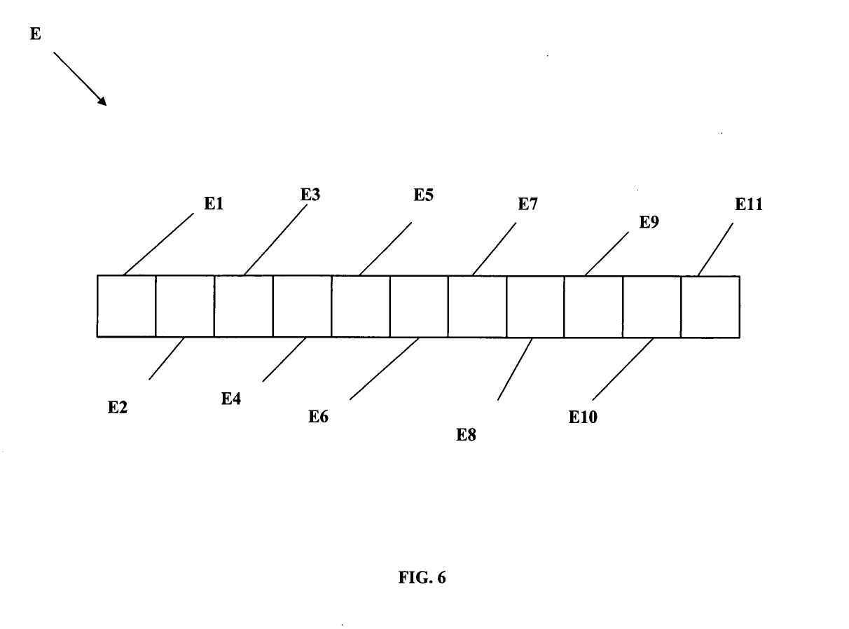

Various configure priorities may be applied to events E. Examples of criteria used wholly or partially assign a priority and/or an event priority index value I7 (as introduced in the discussion of FIG. 6 below) may include (1.) whether a source network address I3 (also as introduced in the discussion of FIG. 6 below) or identification of a communicator or source of a message M related to or identified by the instant event E has previously been associated with suspicious activity; (2.) whether the destination network address I4 is considered to related to a critical and/or popular asset of the network 2; and (3.) whether a service or destination network address I4 (as introduced in the discussion of FIG. 6 below) of the event E might be related to an asset 4, 5, 10, and 11 of the network 2 that is vulnerable or particularly vulnerable to an attack or intrusion attempt potentially indicated by the instant event E.

Incidents, i.e., grouped aggregations of events E, may possibly be updated by incorporation of one or more additional events E. The pipeline P comprises the fourth segment of the event correlation pipeline ECP. Finally the events E may, in various alternate preferred embodiments of the Method of the Present Invention, be indexed for long term storage, and various statistical report tables TB, CTB, & TR may be partially or wholly updated within the pipeline P and/or by a fifth segment ECP.5 of the event correlation pipeline ECP.

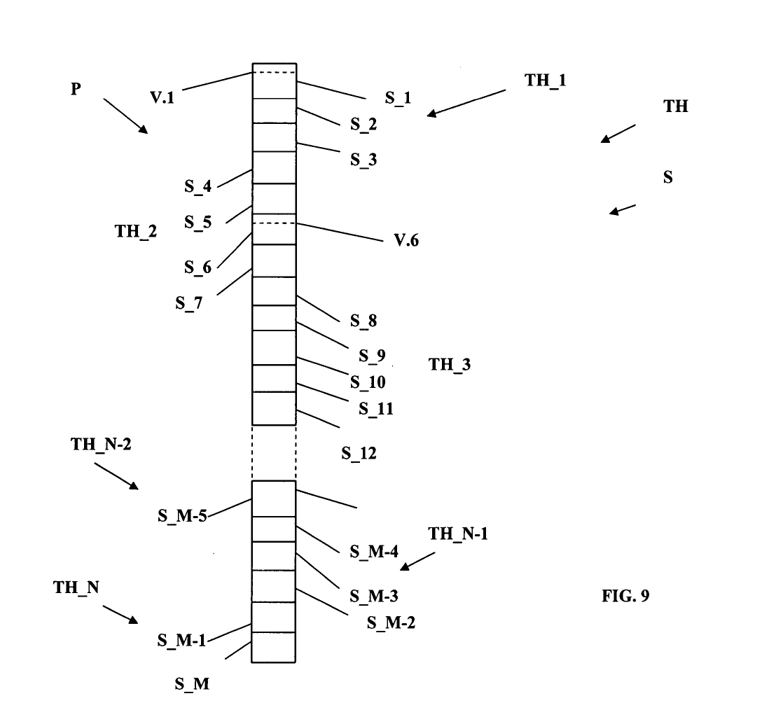

Referring now generally to the Figures and particularly to FIGS. 5, and 9, FIG. 5 is a schematic of the main event buffer B and FIG. 9 is a schematic of the pipeline P, wherein the main event buffer B and/or the pipeline P may be stored within the main memory 12, within the on-chip cache 14, the off-chip cache 18, and/or and on-chip cache 40 of an additional processor 34. As presented in FIG. 9, each thread TH, i.e., TH_1, TH_2 through TH_N, of the pipeline P of may include one or more stages S as described in FIG. 9. The stages S are applied in an ascending order S_1 through S_M as presented in FIG. 9, where the values 1 through N and 1 through M are all integers. An initial thread TH_1 includes stages S_1, S_2 and S_3. A first thread TH_2 includes stages S_4 through S_7, a second thread TH_3 includes stages S_8 through S_12. Towards the end of the pipeline P a last thread TH_N includes a last stage S_M and a next to last stage S_M−1, where N is an integer equal to the total number of ordered threads TH_I through TH_N and M is an integer equal to the total number of ordered stages S of the pipeline P.

Referring now generally to the Figures and particularly to FIGS. 2 and 5, within the network computer 8 that creates events E, events E may be consolidated by the instant network computer 8 to reduce the volume of the events E, then packed together into packets PK, signed, encrypted, and transmitted to the first system 4. The first system 4, or optionally a network computer 8, is responsible for decrypting and authenticating the packet PK of events E prior to application of the pipeline P by the first system 4.

Once the first system 4 has the packet, it is read and initially processed by an initial reader thread TH_I. This initial reader thread TH_I checks whether any packets PK have been dropped, and if so the initial reader packet thread TH_I arranges for a retransmission of the missing packets PK from the originating network computer 8 or via the network 2. The individual events E within the packet PK are identified, sanity checked (to avoid consuming events with hopelessly bad timestamps for example), data fields are changed to host byte order, and duplicate events E from different network computers 10 are consolidated.

The initial reader thread TH_I copies events to a main event buffer B where they are processed by the main event pipeline P. This occurs in a series of stages S which are discussed below. A static configuration may be applied to modify the event priority index value I7 of an event priority data field E7 of the event E, early or during the processing of the events E by application of the pipeline P. Statistical profiles that are being maintained in a separate table TB are updated, based on the instant event E, and then update the event priority index value I7 of the event E is appropriately updated. A permanent storage index may be maintained in a table TB and updated to aid in finding this event E when the events E later stored on the secondary memory 22. Finally, any additional reporting tables TR are updated. At a later stage S, the event E will get offloaded to the secondary memory 22, and where it may eventually be deleted or archived. It is understood that the tables TB, configuration tables CTB and reporting tables TR may be instantiated within the main memory 12, on-chip cache 14, the off-chip cache 18, and/or and on-chip cache 40 of an additional processor 34.

When a packet of events E first arrives at the first system 4, the events E are copied into a fixed buffer FB of the on-chip cache memory 14 where the initial thread TH_I processes the events E. Selected operations are performed on the event E in the fixed buffer FB, including determining whether the event E is formed properly enough to process, and deciding if the event E is a duplicate and shall be consolidated.

Once these stage operations are done, the event E is moved to the main event buffer B. The main event buffer is optimally located within the on-chip cache memory 14 and my alternatively or additionally located in part or in whole in the off-chip cache memory 18, and/or one or more additional on-chip cache memories 40. The event E is maintained in an event space ES while main pipeline correlation operations are performed, and where the event E is stored until the event E is transferred to the secondary memory 22. The location of the main event buffer B storing the event space ES is then eventually reformatted and overwritten with newer events E, as the main event buffer B is a circular buffer.

An event E in the correlation system is associated with additional information which captures the current state of correlation with respect to the event E. For this reason, events E are stored and associated with an extended event EE of the event space ES wherein the event is stored. Different stages S of the pipeline P will record results of calculations in the extended event structure EE, reporting table TR and/or tables TB, and later stages S will read it, in addition to reading the original attributes of the event E as created by the network computer 8 or first system 4 that originated the event E. In a checkpoint operation the contents of the events space ES and any tables TB and reporting tables TR associated with the event E are stored in the secondary memory.

Thus a main event buffer B comprises a series event spaces ES comprising an alternating extended event structure EE followed by the event E. In certain other additional alternate preferred embodiments of the Method of the Present Invention, the event space ES is generally less than 128 bytes, but may be longer if either the event E is longer than 96 bytes or the additional information stored in the extended event structure EE is more than 32 bytes).

An anatomy of a main event buffer is shown in the FIG. 5. Generally the main event buffer B begins empty, and the region R1 at right remains empty until the main event buffer B is entirely used up. The second region R2 is an area of the main event buffer B into which the initial reader thread TH_I is consolidating events E as they arrive. Once events E have timed out, a series of one or more main event pipeline threads TH applies the main pipeline stages S to these events E in a third region R3. Finally, events E that are fully processed await storage (or queries) at the left hand end of the main event buffer B at a fourth region R4.

Serialization may occur in a fifth region R5 in a batch mode, with a range of event spaces ES of the event buffer B, i.e., representing some selected time period, is pushed to the disk 28 of the secondary memory 22. The range of event spaces ES may be serialized either because it times out, or because it exceeds a maximum size. A multi-dimensional index is built and updated within a table TB as the events E are processed. The multi-dimensional index used for serialization and later queries. A time period for a buffer B may be an hour under normal operating loads in certain still other alternate preferred embodiments of the Method of the Present Invention.

The main event pipeline P consists of a series of stages S, many of which may have conceptually similar structure, and which are applied to events E in turn. A stage S typically is associated with a particular hash table, and involves the following steps:
1. Read some data out of the event E and form it into a hash table index;
2. Look up the relevant row in of the associated hash table of the instant stage S;
3. Update the row (if the hash table is a state table); and
4. Write back into the extended event structure EE or the event priority data field as directed by the stage S in light of result(s) of the computation performed by the stage S_{—}

The stages S are all applied sequentially to any given event E. Depending on the first system 4, the main pipeline P can be conducted by one or a number of threads TH. Each thread TH works its way through the main event buffer one event at a time, applying all stages S of the instant thread TH in sequence to that event E. If there are multiple threads TH, they each thread TH take an ordered group of stages S_ A first thread TH_1 will work its way through a range of event spaces ES applying its group of stages S to them one at a time. When the first thread TH_1 has finished a range of event spaces ES, the first thread TH_1 places that range on a producer-consumer queue for which the second thread TH_2 is a consumer. The second thread TH_2 will then apply its stages S to that designated range of events E. If the second thread TH_2 catches up with the first thread TH_1, the second thread TH_2 will pause in execution until another range to be put on the producer-consumer queue. The first system 5 is a computational engine that may be assigned to execute any thread TH waiting for a range to be placed on the producer-consumer queue may be released to perform other operations until a range starting with an event space ES having a stage index SI indicating readiness of the related event E for processing by the inquiring thread TH.

Where the first system 4 comprises a single one-core processor with no or inefficient hyperthreading as the processor 16, all main pipeline stages S shall be performed by one thread TH. For multiple processors 34, or multiple cores 36, 38 and hyperthreads, the main pipeline stages S may be split up between threads TH and the stages S will be assigned to threads TH to improve or maximize performance of the first system 4 in processing the events E.

Generally, only the thread TH managing a particular stage S is allowed to write to a particular and associated state table TB. There are various query and checkpoint threads which may need to read that associated table TB. Depending on the table TB, there may need to be either row or table locks, or it may be adequate for a thread TH to perform a dirty read. For configuration threads TH, only the configuration thread TH can write to a configuration table CTB. One or more of the following tables TB and CTB may be created and maintained by one or more main pipeline stages S that may be comprised within the pipeline P:

Destination Popularity Table

The destination popularity table TB keeps track of the most frequently accessed destinations, as evidenced by flow logs. The destination popularity table TB is used to create a destination anomaly score that is utilized by later pipeline stages S. The destination popularity table TB also can affect priority when we are configured to prioritize attacks on heavily used servers.

Configured Asset Table

The configured asset table TB is a configuration table CTB which keeps tracks of assets on the network that have been configured by the security administrator with a name and a priority. The configured asset table TB is used to increase the priority of attacks on those assets.

Event Type Maliciousness Table

The first system 4 will come supplied with a maliciousness estimate for all event types stored in this event type maliciousness table TB. The sys admin may reconfigure the event type maliciousness table TB. This event type maliciousness table TB will factor into certain types of events E having higher priority than others, and this will be discovered on a dedicated event type hash lookup in this table.

Suspicious Source Table

The sys admin can specify IP sources which are of particular interest, and then events E from those sources will get a priority boost. This will be determined at the time a thread TH looks up a source IP address in suspicious source table TB.

Vulnerability/Application Map Based Priority

The sys admin can also import a Nessus report which indicates that certain IP destinations have particular vulnerabilities or particular applications. This information is stored in the vulnerability/application map based priority configuration table CTB.

Behavior Profile Tables

These behavior profile tables TB are used to keep track of the way an internal computers 11 and network computers 10 behave, and to notice if there is a change in behavior. This information can be combined with other evidence to corroborate that something of concern is really happening, or simply to provide the sys admin with additional events to use in forensics. The behavior profile tables TB keep track of the typical services used by the associated internal computer 11 or network computer 10 (both inbound and outbound), the typical IP destinations the internal computer 11 or network computer 10 talks to, and the total amount of data the instant internal computer 11 or network computer 10 normally sends and receives.

Mapping Tables

These mapping tables TB are used to keep track of the history of how IP addresses relate to MAC addresses, and also how sys admin names relate to IP addresses. Since these associations change over time, an historical record is maintained around in order that we can answer queries about particular sys admin names and MAC addresses

Incident Tables

Incident tables TB are used to keep track of possible incidents in the making (scans, worms, intrusions, etc). Typically an event E will satisfy some condition which will cause the creation of an incident table entry. Then events E matching some condition to be related to this uniquely identified condition will be added to the possible incident, until the event E crosses a threshold and becomes a fully fledged real incident which can be recorded, or reported to the sys admin. The total priority of the incident will be used to determine whether or not an aggregate is so reported. Incidents that continue to grow and change may be updated to the sys admin every time the incidents cross a series of exponentially increasing thresholds.

False Positive Detection Tables

Events E which appear to be uninteresting false positives based on their statistical behavior can be downgraded in their priority. This false positive table TB keeps track of the relevant statistical estimators of false positive behavior, and the stage modifies priority appropriately.

Disk Storage Index

Events may be referenced on a disk 28 via a tree data structure. A stage S in the event pipeline P updates the relevant tree structure. However, the events E are not immediately pushed to disk by this stage S and the disk storage index table TB may optionally be used to keep the data structures updated so that when the time comes, the events E can be efficiently batched up and stored on disks in a manner that facilitates efficient retrieval given the peculiar performance envelope of disks 28.

Report Statistics Tables

There are a number of stages S associated with different tables CTB and TB that are used for preformatted reports. Generally these associated tables TB and CTB are kept constantly up to date and then archived as a unit, which enables increased interactivity by the sys admin.

The tables TB, CTB and TR may, in various additional alternate preferred embodiments of the Method of the Present Invention, be instantiated and maintained in the additional processors 34 as well as the main memory 12, the on-chip cache memory 14 of a central processing unit 16, and/or an off-chip cache memory 18 of the first system 4 as a whole or in a distributed data structure.

Referring now generally to the Figures and particularly FIG. 6, FIG. 6 a format diagram of an event E received or generated by the first system 4 of FIG. 2. As new events E are generated or received by the first system 2, it becomes necessary to move old events E onto the secondary memory 22. Entire main buffers B will be moved as a batch after main event processing on them has been completed. The event processing pipeline P will maintain a multi-dimensional tree index TB into the events E. Conceptually, an event E may be viewed as a point in a six dimensional space, where the dimensions are:

EventType

Source IP

Destination IP

Time

Destination Port

Priority

The nodes in the tree model 6-dimensional rectangles in this space, and enclose the rectangles of child nodes. Leaf nodes hold some events E, and the minimal rectangle necessary to enclose them. This structure is a variant of a computer graphics data structure known as an R-tree.

The serialization algorithm works its way down the R-tree for a particular main event buffer B, and finds subtrees which are about the right size to be serialized to disk in a single chunk. Once written, a chunk will only ever be read as a complete entity, and its tree structure will be recreated during reading. A main event buffer B will typically be stored as a few hundred chunks like this, together with the top level structure necessary to decide which chunks are needed to handle any given query. The goal is that most queries can be handled in only a few chunk reads.

The event E may include information conforming to the Internet Protocol (hereafter “IP”) is formatted accordingly as:
a. an event identifier field ID-E;
b. a time field E1, containing an I1 time index value;
c. event type field E2, containing an I2 ET index value;
d. source IP address field E3, containing a source network address I3 index value;
e. destination IP address field E4, containing a destination network address I4 index value;
f. destination port field E5, containing an I5 index value;
g. sourcing switch/physical port field E6, containing an I6 index value;
h. event priority field E7, containing an I7 index value; and
i. message information field(s) E8 through E11, containing an information extracted from or derived from the message M.

The time field E1 contains the index value I1 specifying a time of generation of the event. The event type field E2 stores an identification of type of intrusion event indication that matched the electronic message M. The source IP field E3 stores the source IP address designated by the electronic message M. The destination IP field E4 records the destination IP address designated by the electronic message M. The destination port field E5 stores the destination port designated by the electronic message M. The sourcing switch/physical port E6 contains the switch or physical port from which the electronic message M was received by the network computer 10 or as was designated by the electronic message M. The event priority field E7 records a priority assigned by the network computer 10 or the first system 4 to the event E. One or more message information fields E8 through E11 store information stored in, derived from, or related to, the electronic message M, such as raw text as originally contained in the electronic message from which the security event E was derived.

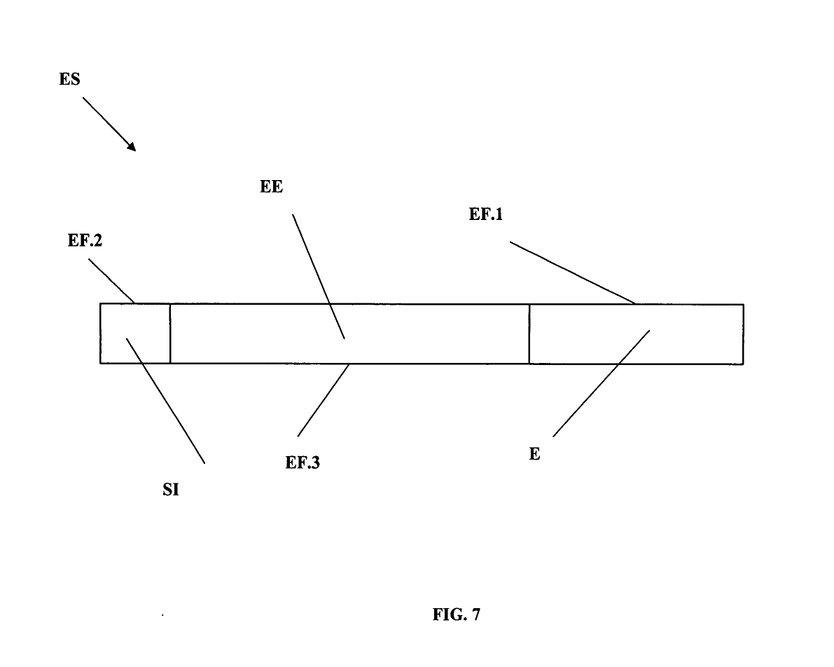

Referring now generally to the Figures, and particularly to FIG. 7, FIG. 7 is a format diagram of an event space ES presents an event data field EF.1 storing the event E of FIG. 3, a stage index data field EF.2 storing a stage index SI and an extended event EF.3 data field storing and extended event EE. The event spaces ES are instantiated as data structures in the circular index buffer of FIG. 5.

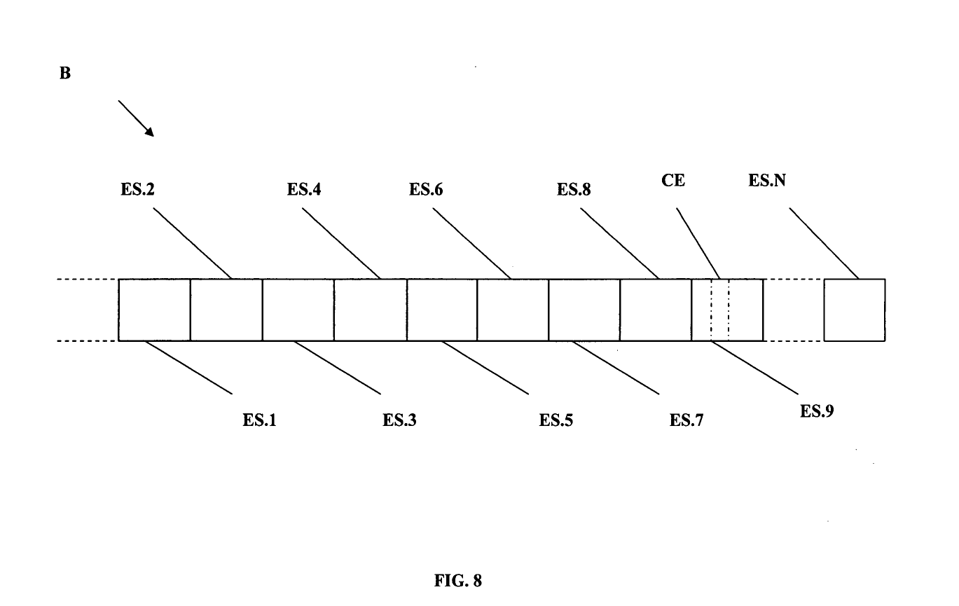

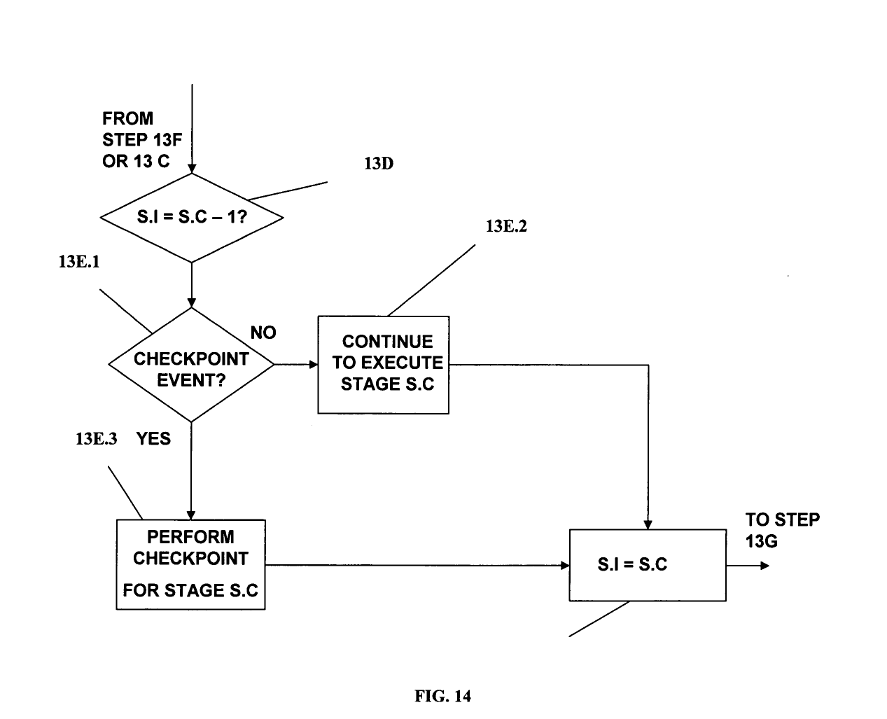

Referring now generally to the Figures, and particularly to FIG. 8, FIG. 8 is a schematic diagram of a plurality of event spaces ES of FIG. 7 within the main event buffer B of FIG. 3 and FIG. 5. Events spaces ES.1 through ES.N are ordered within the main event buffer B in a sequence to insure that the threads TH_1 through TH_N of FIG. 9 are applied against each thread N in ascending order from a first thread TH_1 to a last thread TH_N. The ninth event space ES.9 contains a checkpoint event CE in the event field EF.1. The function of the checkpoint event in certain yet other alternate preferred embodiments of the Method of the Present Invention is described below in reference to FIG. 14 and generally in light of the present disclosure.

Referring now generally to the Figures, and particularly to FIG. 9, FIG. 9 is a schematic diagram of the pipeline P of stages S and threads TH instantiated in the first system of FIG. 2 and configured to process a plurality of events E of FIG. 6 stored in the main event buffer B of FIG. 5. The threads S are each associated with a unique order value V, wherein the associated order value V indicates where the associated stage S shall be applied within a sequence of application of the stages S in accordance with the first method. For example, the stage S_1 is assigned an order value V of one (as indicated by the notation of V.1 shown in FIG. 9 to be comprised within the first stage S_1), and the order value of each successive stage S_1 through S_M is increased by one integer value, wherein the order value of S_M is equal to an order value V of M. Each thread TH_1 through TH_N includes one or more stages S_1 through S_M, wherein the stage S with the lowest order value V of a thread TH_1 through TH_N is the first applied stage S of the associated thread TH and the stage S with the highest order value V of a thread TH_1 through TH_N is the last applied stage S of the associated thread TH. Each thread TH includes a first stage value S.F and a last stage value S.L, wherein the first stage S.F value of a thread TH is equal to the lowest order value V of the stages S_1 through S_M of the instant thread TH_1-TH_N and the last stage value S.L value of a thread TH is equal to the highest order value V of the stages S_1 through S_M of the instant thread TH. For example, the first stage value S.F of the second thread TH_2 is equal to the integer four and the last stage value S.L of the second thread TH_2 is equal to the integer of seven. In a further example, the first stage value S.F and the last stage value S.L of the second to last thread TH_N−2 are equal and equal to the integer value of M less two. By way of illustration, the order value V of the sixth stage S_6 is equal to the integer six and shown to be comprised within the sixth stage S_6 as a sixth order value V.6 in FIG. 9.

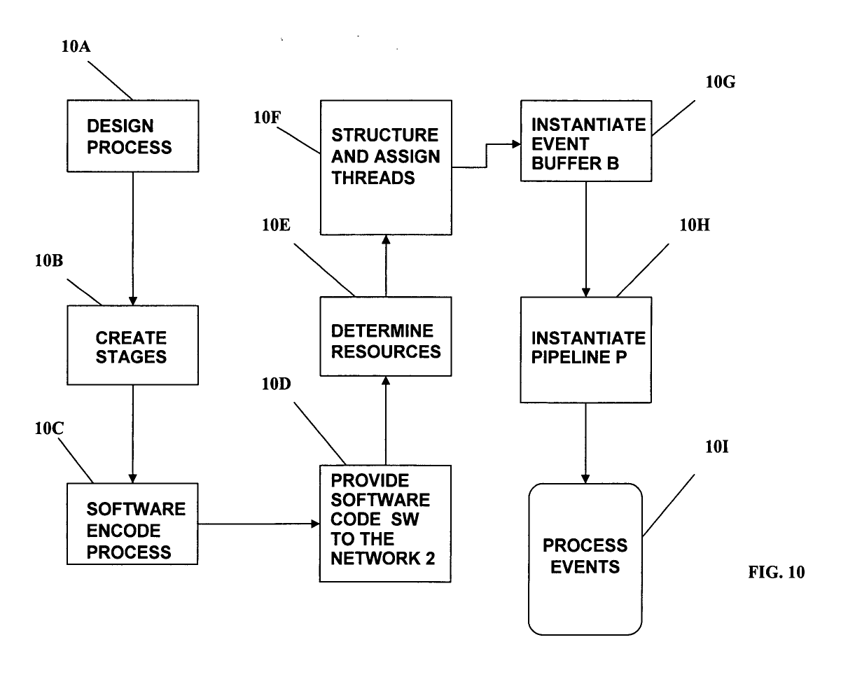

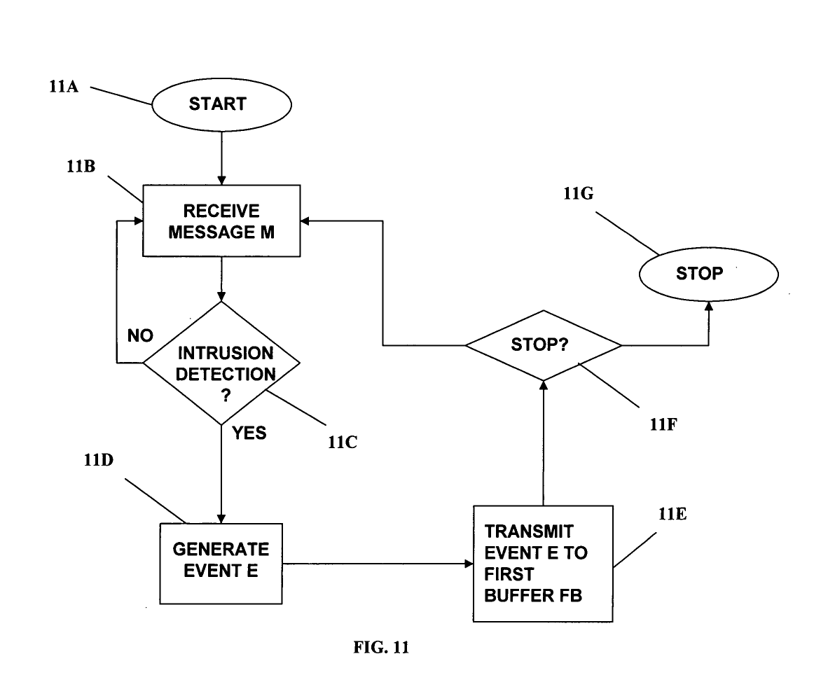

Referring now generally to the Figures, and particularly to FIG. 10, FIG. 10 is a process chart of the first method that may be executed by means of the communications network of FIG. 1 and the first system of FIG. 2. In step 10A the event generation, communication, storage, archive and pipeline process is outlined by a software engineer, optionally with the aid of computer program development design tools. In step 10B the pipeline process is divided into discrete stages S_1 through S_M that may be applied in a sequence. It is understood that the stages S_1 through S_M nay be structured to enable the omission of execution of one or more stages S_1 through S_M as in accordance with the process of step 10A and the characteristics of an event E. The stages S_1 through in S_M are encoded as executable instructions in computer-readable a software SW in step 10C, and the software is provided to the electronic communications network 2, wherein the software is distributed within the network 2, to include the first system 4, and optionally one or more network computers 6, in whole or in part and optionally redundantly to support efficiency and robustness of the execution of the software. The software SW in step 10E locates and identifies discrete computational engines, e.g., the processor 16, the additional processor 34, and/or one or more cores 36, 38 that are available for processing at least one stage S_1 through S_M. The software SW assigns stages S_1 through S_M to threads TH_1 through _TH_N and assigns each thread TH_1 through TH_N to an individual and separately taskable computational engine 16, 34, 36 or 38. In step 10G the main event buffer B is instantiated in the first system 4 and in step 10H the pipeline is instantiated in the first system 4. In step 10I the steps of the software of the FIGS. 11 through 13 are executed until the software SW directs the first system 4 to pause or stop the processing of events E.

Referring now generally to the Figures, and particularly to FIG. 11, FIG. 11 is a flow chart of the generation of an event of FIG. 6 as directed by the software SW of the first method of FIG. 10 and by means of the communications network 2 of FIG. 1 and the first system of FIG. 2. The process of FIG. 11 may be executed by a host system, e.g., the first system 4 and/or one or more network systems 10 and/or internal systems 11 in various yet additional alternate preferred embodiments of the first version. In step 11B a message M is received and analyzed, by suitable intrusion detection techniques known in the art, for indications of association of the message M with a possible intrusion attempt. The software SW determines in step 11C whether an event E shall be generated in step 11D. The event E generated in step 11D is transmitted to a first buffer FB in step 11E, where the transmission of in step 11D of the event E may be accomplished by transmission from an originating internal system 11 or a network system 10, or from within the first system 4 when the event E is originated in the first system 4.

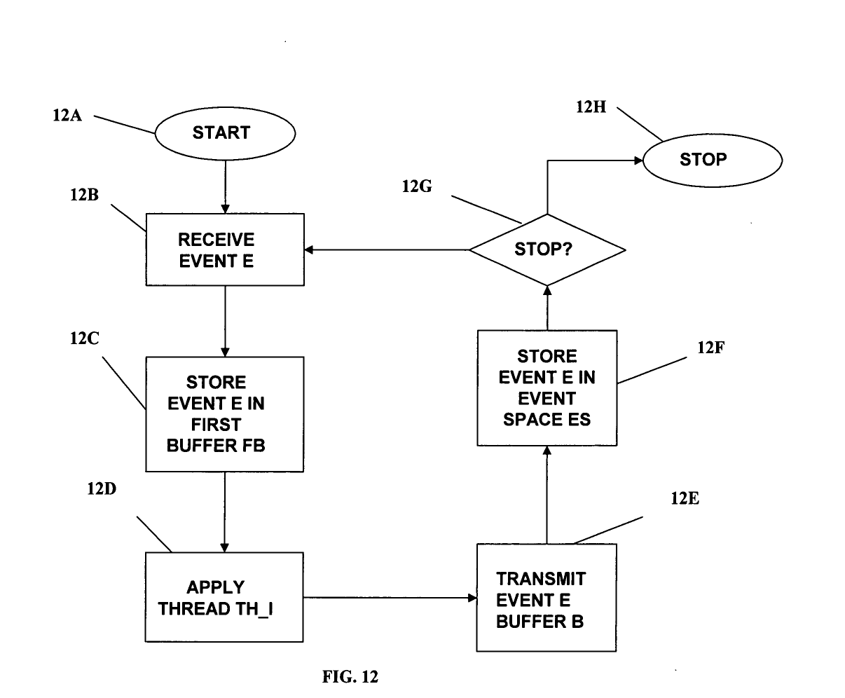

Referring now generally to the Figures, and particularly to FIG. 12, FIG. 12 is a flowchart of the processing of an event E of FIG. 6 by the first system 4 of FIG. 2 and as directed by the software SW in preparation for processing of the event E by the pipeline P. In step 12B the event E is received, either as generated by the first system 4 or alternatively from an internal system 12 or a network computer 10, as also described step 12E. In step 12C the event E is stored in the first buffer FB. In step 12D the initial thread TH_I is applied to the event E and then communicated to and stored in the main event buffer B as presented in steps 12E and 12F.

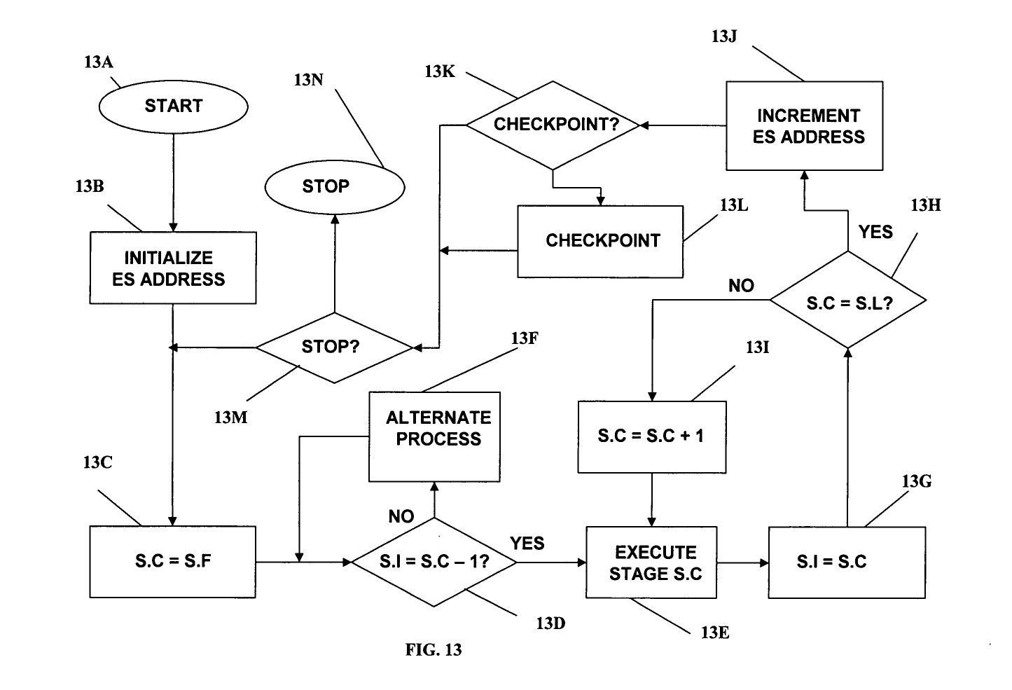

Referring now generally to the Figures, and particularly to FIG. 13, FIG. 13 is a flowchart of an application of a thread TH of the pipeline P of FIG. 9 by the first system 4 of FIG. 2 in accordance with the first method of FIG. 10 and as directed by the software SW. In step 13B the thread TH is provided with an address of an event space ES to begin searching for an event space ES that is appropriate for processing by the instant thread TH. In step 13C a current stage variable S.C is set to be equal to the order value V of the first stage S.F of the instant thread TH. For example, in the case of the second thread TH_2, TH_2 includes stages S.4 through S.7, wherein the fourth stage S.4 is the first stage S.F of the second thread TH_4 and the current stage variable S.C is therefore assigned an order value V equal to the integer four in step 13C of the application of the second thread TH_2.

In step 13D the current stage value S.C is compared against the stage index SI of the event space ES under examination and stored at the ES Address provided to the thread TH. Where the SI is equal to an integer value of one integer value less than the S.C, the first system proceeds from step 13D to execute step 13E and apply the stage S of the thread TH having an order value V equal to the present value of the current stage variable S.C. When the first system 4 determines in step 13D that the stage index SI of the event space ES indicated is not equal to the present value of the current stage variable S.C, the computational engine, e.g., the processor 16, the additional processor 34, or a core 34 or 36, assigned to execute the instant thread TH is released to perform an alternate operation in step 13F before returning to step 13D. The step 13D supports the efficient application of the computational resources of the first system 4 by enabling an computational engine 16, 34, 36 & 38 assigned to a particular thread TH.1 through TH.N to perform other operations, as per step 13F, when the main event buffer B does not present an event space ES that is ready for processing by the thread TH that is assigned to the instant computational engine 16, 34, 36 & 38.

In steps 13A through 13N, and in particular in the execution of steps 13, the thread TH may store information in the extended event EE of the event space ES addressed in step 13D and/or one or more tables TB, configuration tables DTB, and/or reporting tables TR. In step 13G the stage index SI of the event space ES is made equal to the current stage variable S.C, whereby the stage index SI is incremented to be made equal the order value of the stage S executed in the most recently performed step 13E.

The first system 4 determines in step 13H whether the present value of the current stage variable S.C is equal to the last stage value S.L of the thread TH, whereby the first system 4 determines whether all of the stages S of the thread TH have been applied to the event space ES addressed in step 13.D. When S.C is not found to be equal to S.L in step 13H, the current stage variable S.C is incremented in step 13I, and the stage S having an order value V equal to the new value of the current stage value S.C is applied to the instant event space ES in an additional iteration step 13E.

In step 13J the event space address ES Address value is incremented to be equal to an address of a next event space ES to be processed by the instant thread TH. In step 13K the first system determines whether to perform a checkpoint action. In a checkpoint action of step 13L the main event buffer B, the first buffer FB, the tables TB, the configuration tables CTB, the reporting tables TR and other information is stored in the secondary memory as an information storage back-up precaution and to support recovery of the first system 4 in the event of a power failure, system crash or other impairment of the first system 4.

Certain additional alternate preferred embodiments of the Method of the Present Invention include sequentially processing an event E through the sequentially ordered series of stages S, the stages S to be applied in a pre-established sequence to the event E in order from lower S_1 to higher S_M. The stage index SI indicates the last applied stage S, for example S_3, and/or the next higher ordered stage to be applied, e.g. S_4. The stage index SI is examined in step 13D to identify the next higher ordered stage S_4 to be applied, and the application of all stages other than the next higher ordered stage S_4 to the event is inhibited. The next higher ordered stage S_4 is then applied to the event E in step 13E. The stage index SI is updated in 13I to identify the next higher ordered stage as the most recent stage applied to the event. Even other alternate preferred embodiments of the Method of the Present Invention method include updating the stage index SI to indicate a following stage, e.g., S_5, the following stage S_5 to be the stage applied after the application of the next higher ordered stage S_4 and before all other stages S of higher order than the next higher ordered stage S.4 and the following stage S_5.

In certain yet other additional alternate preferred embodiments of the Method of the Present Invention, the determination made in step 13K may be triggered by comparing a time variable TV to a pre-specified time period, e.g. 3 seconds, one minute or 15 minutes, and executed the step 13L only when the time value TV as read in the most recently executed step 13K exceeds the pre-specified time period. The time variable TV may be reset to zero after each execution of step 13L and thereafter incremented by counting clock pulses generated by a real time clock 44 of the first system 4. The first system 4 proceeds from either step 13K or step 13L to step 13M. From step 13M the first system 4 either (1.) ceases or pauses processing in step 13N, or (2.) returns to step 13C and directs the instant thread TH to determine whether the event space ES addressed by the newly incremented address ES Address (as incremented in the step 13J) is available for processing by the instant thread TH.

Referring now generally to the Figures and particularly to FIG. 14, FIG. 14 illustrates a method of still other additional alternate preferred embodiments of the Method of the Present Invention to checkpoint information related to each stage S as a checkpoint event CE is processed by the pipeline P. In the step 13E, comprising substeps 13E.1, 13E.2 and 13E.3, of an optional method of FIG. 14, the checkpoint event CE directs or signals to the first system 4 to store information related to the instant stage S currently processing the checkpoint event CE to be stored in an archive A located in the secondary memory 22. The checkpointed and archived information associated with the instant stage S. i.e., the stage S presently applied to the checkpoint event CE, may be read alternatively, additionally, singularly or in combination from the first system 4, first buffer FB, one or more tables TB, one or more configuration tables CT, one or more reporting tables TR, the buffer B and/or one or more event spaces ES. The checkpoint event CE is processed through the series of stages S in the sequential order; and each stage S is checkpointed when it processes the checkpoint event.

In step 13E.1 the first system 4 determines whether the event E being examined is a checkpoint event CE. Where the instant event E is not determined to be a checkpoint event CE, the information technology system 4 executes the alternate process as directed by machine-readable software encoded instructions in step 13E.2. Where the instant event E is determined in step 13E.1 to be a checkpoint event CE, the information technology system 4 archives information related to the stage S.C in the archive A of the secondary memory 22, wherein the information stored in step 13E.3 is associated with the stage S.C in the archive A.

The application of the checkpoint event CE in the steps of FIG. 14 enable the first system 4 to archive the states of each stage S in an ordered sequence and to support the recovery of the process of the pipeline P in the event of a system crash of the first system 4.

The first system 4 may be configured to read a computer-readable medium, wherein the computer-readable media comprises machine-readable instructions that direct the first system 4 to perform or more of the one information processing steps described herein.

The above description is intended to be illustrative, and not restrictive. The examples given should only be interpreted as illustrations of some of the preferred embodiments of the invention, and the full scope of the invention should be determined by the appended claims and their legal equivalents. Those skilled in the art will appreciate that various adaptations and modifications of the just-described preferred embodiments can be configured without departing from the scope and spirit of the invention. The scope of the invention as disclosed and claimed should, therefore, be determined with reference to the knowledge of one skilled in the art and in light of the disclosures presented above.

We claim:

1. In an information technology system, the information technology system having at least one computational engine available for processing security event data, a method for processing security event data comprising:
a. software encoding machine-readable instructions to execute the security event processing, the instructions organized into modules;
b. providing the instructions to the information technology system;
c. determining the number of computational engines available for security event processing;
d. tasking each available computational engine with executing at least one module; and
e. processing a plurality of events.

2. The method of claim 1, wherein each module is executed exclusively by only one computational engine.

3. The method of claim 1, wherein information generated in the execution of at least one module is written into an extended event structure.

4. The method of claim 3, wherein the information stored in the extended event structure is accessed in the execution of at least one additional module.

5. The method of claim 1, wherein at least one event is stored on a main event buffer of the information technology system.

6. The method of claim 5, wherein the main event buffer is a circular buffer.

7. The system of claim 5, wherein the at least one event is overwritten in the main event buffer after the at least one event is processed.

8. The method of claim 5, wherein the least one event is stored on a secondary memory after processing.

9. The method of claim 8, wherein the secondary memory comprises a data storage disk.

10. The method of claim 1, wherein at least one event is received by the information technology system via an electronic communications network.

11. The method of claim 1, wherein at least one additional event is received by the information technology system via the Internet.

12. In an information technology system, the information technology system having at least a first and a second computational engine, a method for processing security events, comprising:
a. providing a plurality of events to the information technology system, each event having an event type;
b. identifying all events having an identical event type designator; and
c. processing each event sequentially through at least two threads, each thread comprising at least one module and each thread executed by a separate computational engine.

13. The method of claim 12, wherein information generated in the execution of at least one module is stored in an extended event structure.

14. The method of claim 12, wherein the information stored in the extended event structure is applied in the execution of at least one module.

15. The method of claim 12, wherein each event includes information related to a flow event.

16. The method of claim 12, wherein each event further comprises a source dimensional data field storing an electronic message source address.

17. The method of claim 12, wherein each event further comprises a destination dimensional data field storing an electronic message destination address.

18. The method of claim 12, wherein each event further comprises an address dimensional data field storing a value selected from the group consisting of an IP address, a MAC address, and an Ethernet address.

19. The method of claim 12, wherein at least one event is received via an electronic communications network.

20. A computer-readable medium on which are stored a plurality of computer-executable instructions for performing steps (a)-(e), as recited in claim 1.

21. In an information technology system, a method for sequentially processing an event through a sequentially ordered series of stages, the sequentially ordered series of stages to be applied in a pre-established sequence to the event in order from lower to higher, comprising:
a. associating a stage index with an event, and the stage index for indicating a next higher ordered stage;
b. examining the stage index to identify the next higher ordered stage; and
c. inhibiting the application of all stages other than the next higher ordered stage to the event

22. The method of claim 21, wherein the method further comprises applying the next higher ordered stage to the event.

23. The method of claim 22, wherein the method further comprises updating the stage index to identify the next higher ordered stage as the most recent stage applied to the event.

24. The method of claim 22, wherein the method further comprises updating the stage index to indicate a following stage, the following stage to be the stage applied after the application of the next higher ordered stage and before all other stages of higher order than the next higher ordered stage.

25. In an information technology system, the information technology having a secondary memory, a method for checkpointing information related to the processing of events by a sequentially ordered series of stages, comprising:
a. providing a checkpoint event, the checkpoint event for directing the information technology system to checkpoint information related to a stage applied to the checkpoint event;
b. processing the checkpoint event through the series of stages in the sequential order; and
c. checkpointing each stage when each stage is applied to the checkpoint event, wherein information associated with each stage is stored in the secondary memory.
